(19) United States
(12) Patent Application Publication
(10) Pub. No.: US 2012/0072320 A1
(43) Pub. Date: Mar. 22, 2012

(54) Tax-return assembly, apparatus, and method

(76) Inventor: William Kowalski, Rolling Meadows, IL (US)

(21) Appl. No.: 12/924,151

(22) Filed: Sep. 22, 2010

(51) Int. Cl. G07F 19/00

(52) U.S. Cl. 705/31

(57) ABSTRACT

An apparatus, and an associated method for a tax kiosk provides for a tax filer to enter information related to a tax return that is required to be prepared for the tax filer. Both tax-filer information and tax-form information is collected at the kiosk. Once collected, the collected information is sent to a remote location at which the tax return is prepared.

The present invention relates generally to a manner by which to prepare a tax, or other administrative return. More particularly, the present invention relates to a tax-return kiosk assembly and associated apparatus and methodology permitting a tax filer to enter information needed pursuant to preparation of a tax return.

The tax-return kiosk permits a tax filer to enter all required information without need for a separate kiosk operator. Costs associated with the conventional need to man a tax-return station with a tax-preparation professional are avoided.

### BACKGROUND OF THE INVENTION

Preparation and filing of tax returns is, as tax filers well know, an unpleasant necessity. As tax complexity increases, many tax filers obtain professional assistance to prepare the tax return.

A large industry has developed to assist tax filers in the preparation of the tax forms. Often times, a tax-return business maintains an office and tax professionals man the office. Tax filers visit the office, and the tax filer provides the tax professional with the information needed to prepare the tax return. Man power costs associated with the need to man the office with the tax professional become high, limiting the profitability of the tax-return business.

A need therefore exists to provide a better means by which to obtain information needed to assist a tax filer in the preparation of a tax return.

### BRIEF DESCRIPTION OF THE DRAWINGS

FIG. 1 illustrates a functional block diagram of a system in which an embodiment of the present invention forms a portion.

FIG. 2 illustrates a partial functional block, partial schematic illustration of a tax return kiosk assembly of an embodiment of the present invention.

FIG. 3 illustrates another view of the tax return kiosk assembly shown in FIG. 2.

FIG. 4 illustrates a process diagram representative of the process of operation of an embodiment of the present invention.

### DETAILED DESCRIPTION

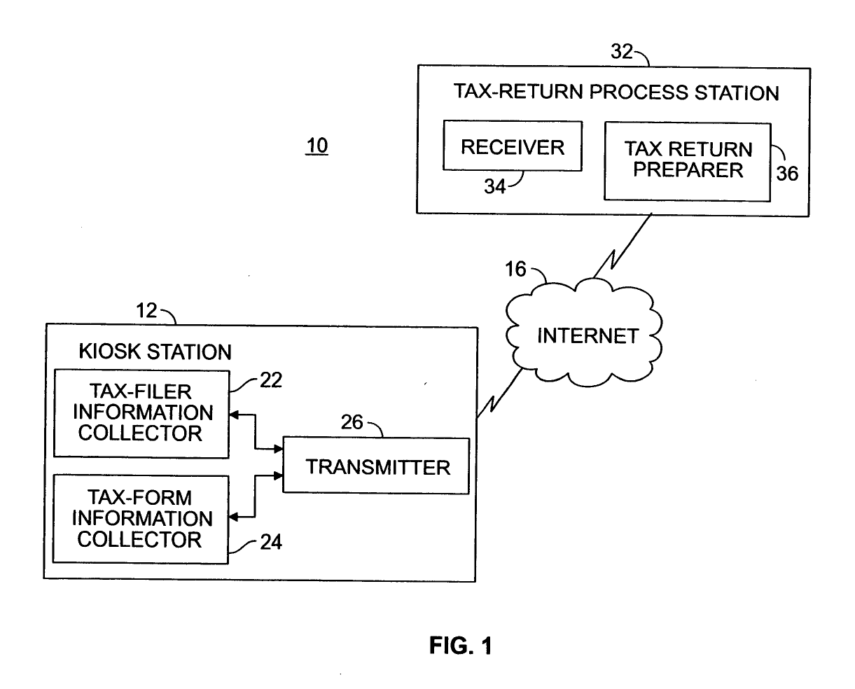

Turning first to FIG. 1, a system, shown generally at 10, includes a kiosk station 12 of an embodiment of the present invention. The kiosk station 12 forms an assembly maintained, e.g., at a self-contained structure including appropriate communication devices permitting its connection to a communication fabric, here the internet 16. In the exemplary implementation shown in FIG. 1, the kiosk station includes a tax filer, information collector 22, a tax form information collector, and a transmitter 26. The information collectors 22 and 24 comprise, for instance, algorithms executable by processing circuitry together with appropriate user interface elements and, e.g., comprise parts of a computer work station, or the like. In other implementations, the information collectors are embodied in other manners.

Collected information is provided to the transmitter 26, which operates to transmit the collected information by way of the internet, or other communication fabric, to a remote location, here a tax-return processing station 32.

The tax-return processing station 32 includes a receiver 34 and a tax-return preparer 36. The receiver operates to receive the information transmitted by the transmitter 26, and the tax return preparer 36 operates to prepare a tax return based upon the received information.

Because the information is collected at the kiosk station 12, and a tax return is prepared remotely, the kiosk station is not required to be manned by a tax-return professional to appropriate construction of the information collectors 22 and 24, the tax filer whose information is collected, is able to enter, or cause to have entered, all of the information required for the preparation of a tax return.

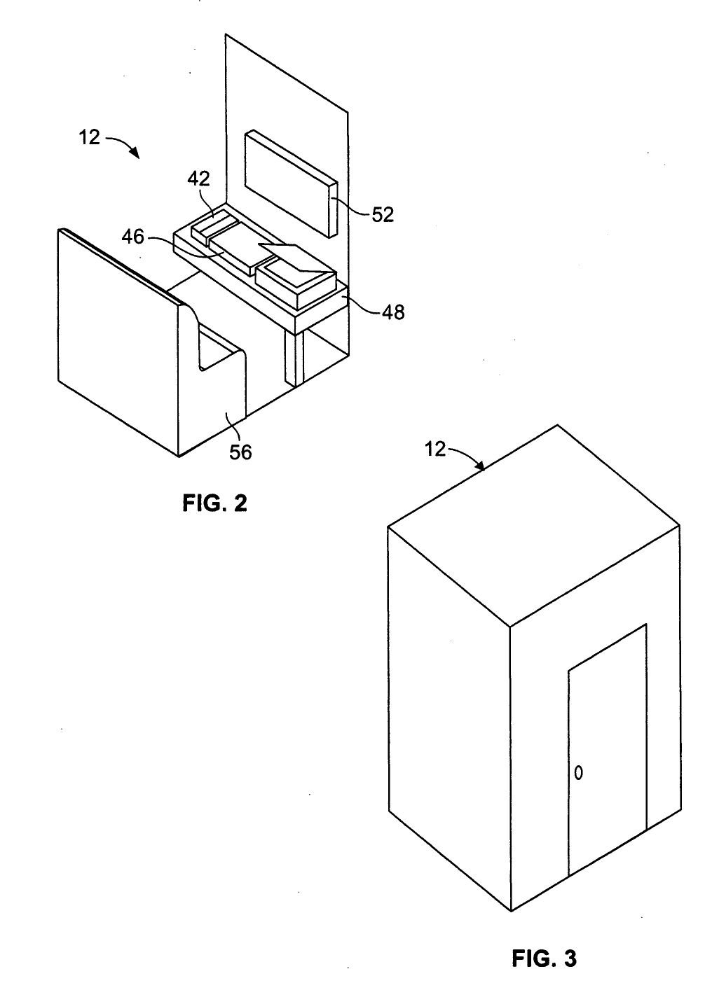

FIG. 2 again illustrates the kiosk station 12 and again shows the information collectors 22 and 24 and the transmitter 26 in block form. FIG. 2 further illustrates user interface elements which are connected to, and form constructive portions of, the information collectors 22 and 24. Here, the user interface elements include a credit card reader 42, a user keyboard 46, a scanner 48, and a display screen 52. The elements 42, 46, 48 and 52 are coupled to, and form functional portions of, the information collectors 22 and 24. The user interface elements 42-52 provide a tax filer with user interface elements permitting the tax filer to input all of the information required to permit the creation of a tax return. Once all the information is provided by the tax filer by way of the input, user interface elements, the transmitter 26 sends the collected information to the remote location for the preparation of the income tax return thereat. In an alternate implementation, rather than sending the information to the remote location, the transmitter 26 provides the information to a locally-positioned processing station. In one implementation, the Kiosk station further includes video conferencing equipment (not separately shown) to permit a tax filer positioned at the Kiosk station to carry out a multi-media communication with a remote location, such as with a tax professional.

In exemplary operation, the tax filer enters the kiosk station and sits at a seat 56, and operation of the assembly commences. A series of instructions are displayed on the screen 52 along with display of a large, and clearly-labeled, illuminated start button. The tax filer presses the illuminated start button, and the tax-filing preparation session commences.

The tax filer first enters charge information by way of the credit card reader 42. In the exemplary operation, instructions are displayed on the screen 52 that notify the tax filer of the documents from which information must be obtained to provide for the completion of the tax return. If the required documents are not available, the tax filer is not charged and the tax filer is instructed, also by way of display upon the screen 52, to return when the documents are available.

If the required documents are available, touch-screen interactive operation commences. The tax filer is asked for the filer's name, address, marital status, etcetera, and any other tax-filer information required pursuant to the preparation of the tax return.

The tax filer is further prompted to enter the tax-form information. In the exemplary implementation, the tax-form information is scanned by way of the scanner 48 to create an electronic copy of the required documents. In one implementation, if legible, the associated tax form is also filled-in. For example, the information from a 1099 interest form is automatically transferred to the appropriate tax schedule. And, the filled-in tax schedule form is displayed on the screen 52 for verification by the tax filer. Any missing information is also requested by way of a display screen on a screen display 52.

Once all of the tax-filer and tax-form information is gathered, and confirmed, the information is transferred, by way of the internet (shown in FIG. 1) or other communication fabric to the remote location, the processing location. At the processing station, the tax-filer's tax return is prepared and, e.g., filed electronically with the appropriate taxing authority, such as the federal tax body or State tax body. Copies of the prepared tax return are mailed, or electronically transferred, to the tax filer. And, in the exemplary implementation, electronic copies of all images are retained for an appropriate time period. In the event that questions arise as to how the tax return was prepared, easy access to the electronic copies permit ready answer to such questions.

FIG. 3 illustrates again the kiosk 12. Here, the kiosk assembly 12 is shown to be a self-contained structure in which the structural components, shown in the view of FIG. 2, are housed.

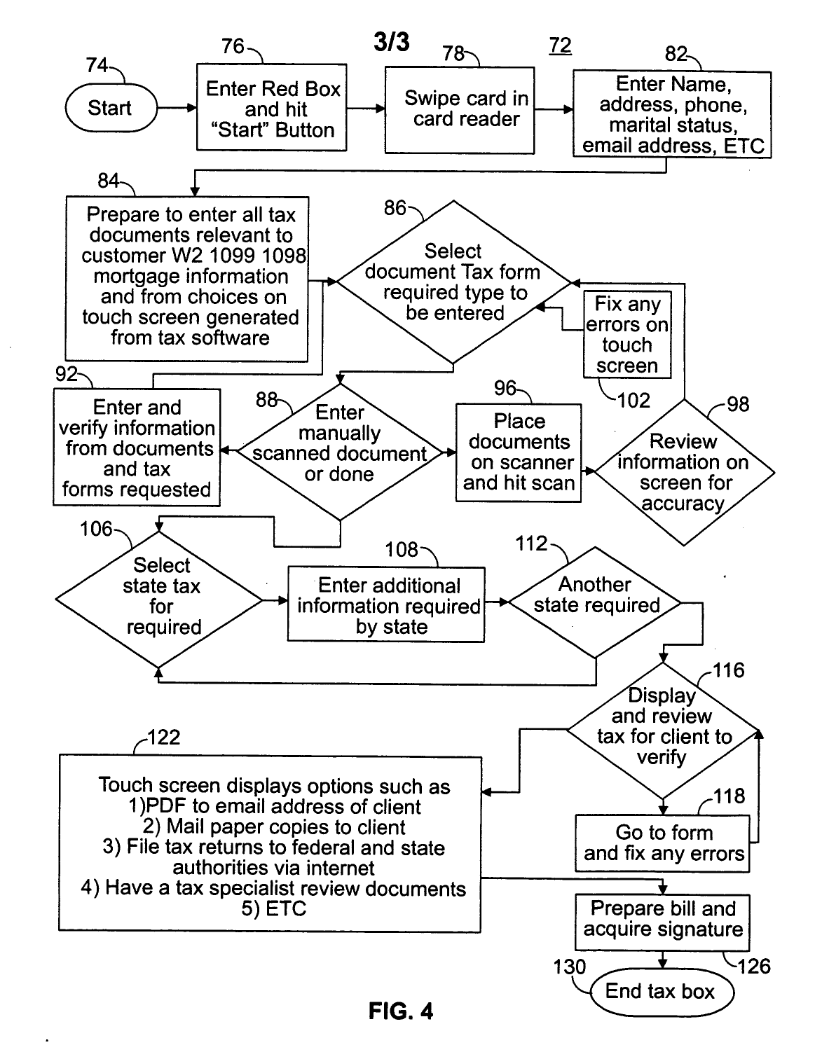

FIG. 4 illustrates a method flow diagram, shown generally at 72, representative of the process of operation of an embodiment of the present invention. After entry, indicated by the start block 74, the tax filer initiates operation by hitting, indicated by the block 76, a start button. Then, and as indicated by the block 78, the tax filer swipes the filer's credit card at a credit card reader.

Then, and as indicated by the block 82, tax-filer information is entered and, as indicated by the block 84, tax-form information is entered.

Then, and as indicated by the decision block 86, a selection is made of the tax-form type that is required. Then, as indicated by the position block 88, a determination is made whether to enter the tax-form information manually or to scan the tax-form-information document, or determine that no information is needed. If manual entry is selected, a branch is taken to the block 92, and the information is entered manually verified. And, a branch is taken back to the decision block 86. If selection is made to scan the documents, a branch is taken to the block 96, and the tax-form information document is placed on the scanner, and the tax filer initiates scanning operations. Then, as indicated at the decision block 98, the scanned information is reviewed for accuracy. If errors are found, a branch is taken to the block 98, and errors are corrected. If no errors are found, the ok branch is taken back to the block 86. And, once the errors are fixed at the block 102, a branch is also taken back to the decision block 86. Multiple iterations through the decision block 86 and 88 are performed, as needed, for the input of all the required information. When decision is made at the block 88 that no more tax-form information remains to be entered, a branch is taken to the block 106, and selection is made as to a state tax form that is required. And, a branch is taken to the block 108, and additional information, if any, required by the selected state is entered. Then, a determination is made at the decision block 112 as to whether an additional state return is required. If so, the yes branch is taken back to the block 106. Otherwise, the no branch is taken to the decision block 116.

At the decision block 116, selection is made to display and review the completed tax form for the tax filer to verify. If verification indicates problems, the no branch is taken to the block 118, and the form containing the errors are corrected a branch is taken back to the decision block 116. If verification of accuracy is affirmed, the done branch is taken to the block 122. At the block 122, options to pertain to further operations are made available to the tax filer, such as to email a PDF copy to the address of the tax filer, mail paper copies to the tax filer, file the appropriate tax returns with the appropriate taxing bodies electronically, have a tax specialist review the documents, or other operations. Then, an invoice is prepared and the signature of the tax filer is acquired, indicated by the block 126, and end of the session, indicated by the block 132, terminates the session.

What is claimed is:

1. A assembly for facilitating tax-filer tax return preparation of a tax return at a tax return kiosk, said kiosk assembly comprising:
a tax-filer information collector configured to provide for tax-filer entry at the tax return kiosk of the tax-filer information;
a tax-form-information collector configured to provide for tax-filer entry at the tax-return kiosk of tax-form information; and
a transmitter embodied at the tax return kiosk configured to transmit the tax-filer information entered at said tax-filer-information collector and the tax-form information entered at said tax-form-information collector, for remote preparation of the tax return.

2. The assembly of claim 1 wherein said tax-filer information collector further comprises a user interface.

3. The assembly of claim 2 wherein said user interface comprises a user keyboard.

4. The assembly of claim 2 wherein said user interface comprises a display screen.

5. The assembly of claim 2 wherein said user interface further comprises a card reader.

6. The assembly of claim 2 wherein the tax filer information further comprises tax-filer payment information.

7. The assembly of claim 2 wherein the tax filer information further comprises tax filer identification information.

8. The assembly of claim 1 where said tax-form-information collector further comprises a user interface.

9. The assembly of claim 8 wherein said user interface comprises a user keyboard.

10. The assembly of claim 8 wherein said user interface comprises a display screen.

11. The assembly of claim 8 where user interface comprises a scanner configured to scan tax-filer-provided sheets to form electronic representation thereof.

12. The assembly of claim 8 wherein the tax-filer-provided sheets comprise tax reporting compliance forms.

13. A processing station for facilitating tax-filer, tax return preparation of a tax return, said processing station comprising:
a receiver configured to receive kiosk-located, tax-filer-entered, tax-filer information and kiosk-located, tax-filer-entered, tax-return-information; and
a tax-return preparer configured to prepare the tax return utilizing the tax-filer information and the tax-return information received by said receiver.

14. The processing station of claim 13 where said receiver comprises an internet-connected receiver configured to receive the kiosk-located, tax-filer-entered information.

15. The processing station of claim 13 wherein the tax-return preparer is further configured to file the tax return, once prepared, with a taxing-authority.

16. A method for facilitating tax-filer, tax return preparation of a tax return, said method comprising:
collecting tax-filer-entered, tax-filer information at a tax-return kiosk;
collecting at the tax return kiosk tax-filer-entered, tax-form information; and
transmitting, from the tax-return kiosk, the tax-filer information and the tax-form information for remote preparation of the tax return.

17. The method of claim 16 further comprising preparing the tax return at the remote location.

18. The method of claim 17 further comprising filing the tax return with a tax authority.

19. The method of claim 18 further comprising retaining a copy of the tax return.

20. The method of claim 18 further comprising providing a copy of the tax return to a tax filer.
